(19) United States
(12) Patent Application Publication
(10) Pub. No.: US 2022/0214444 A1
(43) Pub. Date: Jul. 7, 2022

(54) LIDAR AND RADAR BASED TRACKING AND MAPPING SYSTEM AND METHOD THEREOF

(71) Applicant: KPIT TECHNOLOGIES LIMITED, Pune (IN)

(72) Inventors: Soumyo Das, Pune (IN); Rastri Dey, Pune (IN)

(73) Assignee: KPIT TECHNOLOGIES LIMITED, Pune (IN)

(21) Appl. No.: 17/610,674

(22) PCT Filed: Aug. 2, 2019
(86) PCT No.: PCT/IB2019/056603

§ 371 Date: Nov. 11, 2021

(30) Foreign Application Priority Data
Jun. 14, 2019 (IN) 201921023759

(51) Int. Cl. G01S 13/86; G01S 13/931; G01S 17/931; G01S 13/89; G01S 17/89

(52) U.S. Cl. CPC G01S 13/865; G01S 13/931; G01S 17/89; G01S 13/89; G01S 17/931

(57) ABSTRACT

A system implemented in a vehicle for tracking and mapping of one or more objects to identify free space is disclosed. The system has an input unit having lidar sensors and radar sensors that sense objects in a region surrounding the vehicle, and a processing unit that: receives data from lidar sensors and radar sensors and maps the data in corresponding grid maps of corresponding sensors; tracks objects in regions corresponding to the sensors and performs estimation for objects not sensed by any of the sensors; fuses the grid maps by converting them from sensor frame to vehicle frame to generate a fused grid map; and integrates the fused grid map with any or a combination of track management and scan matching to perform classification of the one or more objects into static objects or dynamic objects and identification of free space in the fused grid map.

### FIELD OF DISCLOSURE

Present disclosure relates to vehicle navigation systems. More particularly, it relates to a system for tracking various objects around a vehicle.

### BACKGROUND OF THE DISCLOSURE

A reliable target detection and tracking system is a key element in vehicle automation. Tracking systems use numerous sensors such as radar sensors and LIDAR (Light Detection and Ranging, interchangeably termed as lidar herein) sensors for tracking targets or objects that are important for manoeuvring of the host vehicle. While tracking an object moving from one zone of sensing devices to another, radar sensing provides minimal data points of the target (object) while lidar sensing provides point cloud with background noise and ground reflection. Hence optimal track management strategy and free space detection for the target when the target is moving with high velocity and manoeuvring is a problem due to background objects, probable clutters or false positives.

Further, various existing systems are not able to provide 360 degree target tracking and mapping even while using high computing power, thereby compromising with the accuracy. Another problem in existing approaches is synchronization and classification of data points captured by lidar sensors and radar sensors.

There is therefore a need in the art for a system and a method to overcome above-mentioned and other disadvantages of the existing approaches for target tracking and free space detection.

### OBJECTS OF THE INVENTION

Some of the objects of the present disclosure, which at least one embodiment herein satisfies are as listed herein below.

It is an object of the present disclosure to provide for a system that integrates track management with grid mapping to enable 360 degree target tracking and mapping.

It is an object of the present disclosure to provide for a system that uses less computation power and is more responsive.

It is an object of the present disclosure to provide for a system that has greater accuracy in terms of tracking surrounding objects than camera based systems.

It is an object of the present disclosure to provide for a system that eliminates ground data and consequent errors due to rough or turbulent ground surfaces.

It is an object of the present disclosure to provide for a system that helps in surround view creation or tracking of non-sensing region of any of the sensors (blind zone area tracking).

It is an object of the present disclosure to provide for a system that identifies various occlusions with improved accuracy.

It is an object of the present disclosure to provide for a system that improves zone or track initialization over conventional averaging techniques.

It is an object of the present disclosure to provide for a system that has improved segregation of static and dynamic targets.

It is an object of the present disclosure to provide for a system that provides for an improved approach for pedestrian classification.

It is an object of the present disclosure to provide a system that enhances the possibility of scanning complex environment of crowded city and un-predictable movement of surrounding traffic vehicles and pedestrians.

It is an object of the present disclosure to provide a system that tracks the non-linear and highly manoeuvring movement of targets and provide detailed information for free space availability for host vehicle navigation.

It is an object of the present disclosure to provide a system that has increased range of detection than camera based systems.

### SUMMARY

This summary is provided to introduce simplified concepts of a lidar and radar based tracking system and method thereof, which are further described below in the Detailed Description. This summary is not intended to identify key or essential features of the claimed subject matter, nor is it intended for use in determining or limiting the scope of the claimed subject matter.

An aspect of the present disclosure provides a system implemented in a vehicle for tracking of one or more objects to identify free space, said system comprising of an input unit comprising: one or more lidar sensors and one or more radar sensors to sense surrounding of the vehicle, wherein each of the one or more lidar sensors and one or more radar sensors sense the one or more objects in a corresponding region; a processing unit comprising a processor coupled with a memory, the memory storing instructions executable by the processor to: receive lidar data from the one or more lidar sensors and radar data from the one or more radar sensors and map the received lidar data and the received radar data in corresponding one or more grid maps of the one or more lidar sensors and the one or more radar sensors; track the one or more objects in one or more regions corresponding to the one or more lidar sensors and the one or more radar sensors and performing state estimation for the one or more objects that are not sensed by any of the one or more lidar sensors and the one or more radar sensors; fuse the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more objects into static objects or dynamic objects and identification of free space in the fused grid map.

In an embodiment, the one or more lidar sensors and the one or more radar sensors are configured on surface of the vehicle to sense the objects in corresponding one or more majorly non-overlapping regions to capture 360 degree view around the vehicle.

In an embodiment, the processor eliminates one or more data points pertaining to ground, from each grid map, by computing a surface normal using at least three data points selected from the lidar data and at least three data points are spaced at a distance less than a pre-defined threshold among each other.

In an embodiment, the processor eliminates the one or more data points pertaining to the ground by computing height of each data point from the ground and considering target distance height of the lidar sensor with the computed surface normal.

In an embodiment, when the one or more objects are tracked in the one or more regions, the processor performs track initialization based on: target information, tracking time, sensor type (lidar or radar) etc. to ensure that the track is created properly which necessitate the track management; weighted fusion based velocity estimation of the tracked one or more objects based on lidar and radar tracking time; and occlusion identification based on the one or more objects sensed by the one or more radar sensors.

In an embodiment, the processor further synthesizes an environment to create an environment map, and the environment map is memorized to be used for performing the classification of the one or more objects and thereby determining availability of free space.

In an embodiment, when at least one object of the one or more objects is a pedestrian, the at least one object is classified using: size of a point cloud pertaining to the pedestrian, obtained from the lidar data, with respect to longitudinal, lateral distance from the vehicle and zone of the point cloud; structure and availability of the point cloud in one or more channels of the one or more lidar sensors; a deterministic velocity vector of the point cloud indicating velocity vector of the pedestrian; and history of trajectory of the point cloud.

In an embodiment, the processor reconstructs and maps one or more cluster points, obtained from lidar data, on one or more data points obtained from radar data for mapping of the one or more objects on the fused grid to form complete surroundings around the host vehicle.

Another aspect of the present disclosure relates to a method carried out according to instructions stored in a computer implemented in a vehicle for tracking of one or more objects to identify free space, comprising: receiving lidar data from one or more lidar sensors and radar data from one or more radar sensors and mapping the received lidar data and the received radar data in a grid, wherein each of the one or more lidar sensors and one or more radar sensors sense the one or more objects in a corresponding region; tracking the one or more objects in one or more region corresponding to the one or more lidar sensors and the one or more radar sensors and performing state estimation for the one or more objects that are not sensed by any of the one or more lidar sensors and the one or more radar sensors; fusing the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more static or dynamic objects and identification of free space.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1A illustrates overall working of lidar and radar based tracking system in accordance with an exemplary embodiment of the present disclosure.

FIG. 1B illustrates architecture of the system in accordance with an exemplary embodiment of the present disclosure.

FIG. 2 illustrates exemplary modules of a processing unit in accordance with an embodiment of the present disclosure.

FIG. 3 illustrates a grid based 360 degree surround view system in accordance with an exemplary embodiment of the present disclosure.

FIG. 4 illustrates environment ground data elimination based on surface normal plane computation and height of point from ground in accordance with an exemplary embodiment of the present disclosure.

FIG. 5A illustrates grid fusion in accordance with an exemplary embodiment of the present disclosure.

FIG. 5B illustrates representation of environment synthesis and memorization in accordance with an exemplary embodiment of the present disclosure.

FIG. 6 illustrates joint track management and scan matching for dynamic target classification in accordance with an exemplary embodiment of the present disclosure.

FIG. 7A illustrates point cloud distribution for a pedestrian in accordance with an exemplary embodiment of the present disclosure.

FIG. 7B illustrates re-mapping of lidar cluster to radar feedback and tracked object to establish efficiency of whole grid in accordance with an exemplary embodiment of the present disclosure.

FIG. 8 illustrates a method of performing lidar and radar based tracking in accordance with an exemplary embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Systems depicted in some of the figures may be provided in various configurations. In some embodiments, the systems may be configured as a distributed system where one or more components of the system are distributed across one or more networks in a cloud computing system.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein may be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Present disclosure relates to a system for tracking various objects around a vehicle. More particularly, it relates to a lidar and radar based tracking system that uses sensor data fusion for tracking of objects and free space detection around the vehicle.

An aspect of the present disclosure provides a system implemented in a vehicle for tracking of one or more objects to identify free space, said system comprising: an input unit comprising: one or more lidar sensors and one or more radar sensors to sense surrounding of the host vehicle, wherein each of the one or more lidar sensors and one or more radar sensors sense the one or more objects in a corresponding region: a processing unit comprising a processor coupled with a memory, the memory storing instructions executable by the processor to: receive lidar data from the one or more lidar sensors and radar data from the one or more radar sensors and map the received lidar data and the received radar data in corresponding one or more grid maps of the one or more lidar sensors and the one or more radar sensors; track the one or more objects in one or more regions corresponding to the one or more lidar sensors and the one or more radar sensors and performing state estimation for the one or more objects that are not sensed by any of the one or more lidar sensors and the one or more radar sensors; fuse the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more objects into static objects or dynamic objects and identification of free space.

In an embodiment, the one or more lidar sensors and the one or more radar sensors are configured on surface of the vehicle to sense the objects in corresponding one or more majorly non-overlapping regions to capture 360 degree view around the host vehicle.

In an embodiment, the processor eliminates one or more data points pertaining to ground, from each grid map, by computing a surface normal plane using at least three data points selected from the lidar data and the at least three data points are spaced at a distance less than a pre-defined threshold among each other.

In an embodiment, the processor eliminates the one or more data points pertaining to the ground by computing height of each data point from the ground and considering target distance height of the lidar sensor with the computed surface normal plane.

In an embodiment, when the one or more objects are tracked in the one or more regions, the processor performs track initialization based on: target information, track history, sensor type associated with track initialization to ensure that the track is maintained properly; weighted fusion based velocity estimation of the tracked one or more objects based on lidar and radar tracking time; and occlusion identification based on the one or more objects sensed by the one or more radar sensors in addition to occlusion identified by lidar.

In an embodiment, the processor further synthesizes an environment to create an environment map, and the environment map is memorized and used for performing the classification of the one or more objects for identification of free space in the fused grid map.

In an embodiment, when at least one object of the one or more objects is a pedestrian, the at least one object is classified using: size of a point cloud pertaining to the pedestrian, obtained from the lidar data, with respect to relative longitudinal, lateral distance from the vehicle and zone of the point cloud; structure and availability of the point cloud in one or more channels of the one or more lidar sensors; a deterministic velocity vector of the point cloud indicating velocity vector of the pedestrian; and history of trajectory of the point cloud.

In an embodiment, the processor reconstructs and maps one or more cluster points, obtained from lidar data, on one or more data points obtained from radar data for mapping of the one or more objects on the fused grid map to form complete surroundings around the host vehicle.

Another aspect of the present disclosure relates to a method carried out according to instructions stored in a computer implemented in a vehicle for tracking of one or more objects to identify free space, comprising: receiving lidar data from one or more lidar sensors and radar data from one or more radar sensors and mapping the received lidar data and the received radar data in a grid, wherein each of the one or more lidar sensors and one or more radar sensors sense the one or more objects in a corresponding region; tracking the one or more objects in one or more region corresponding to the one or more lidar sensors and the one or more radar sensors and performing state estimation for the one or more objects that are not sensed by any of the one or more lidar sensors and the one or more radar sensors; fusing the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more static or dynamic objects and identification of free space in the fused grid map.

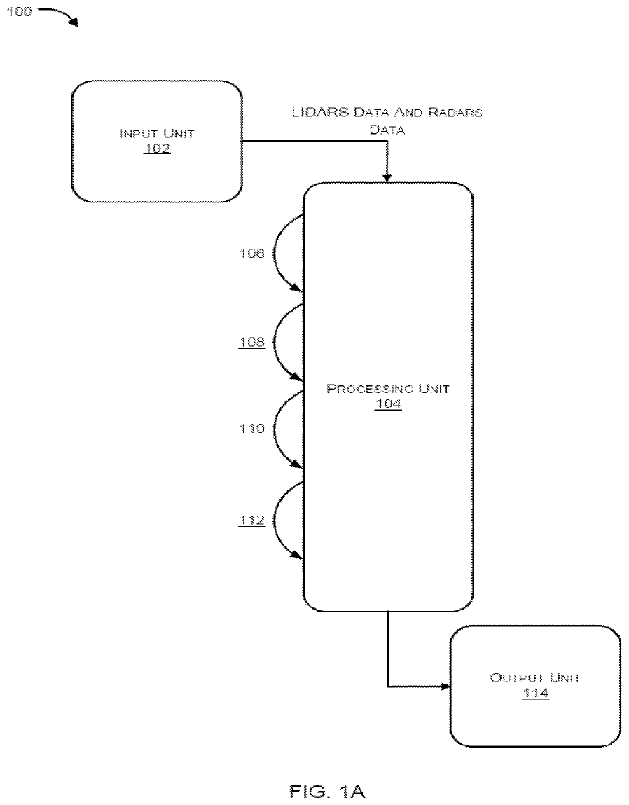

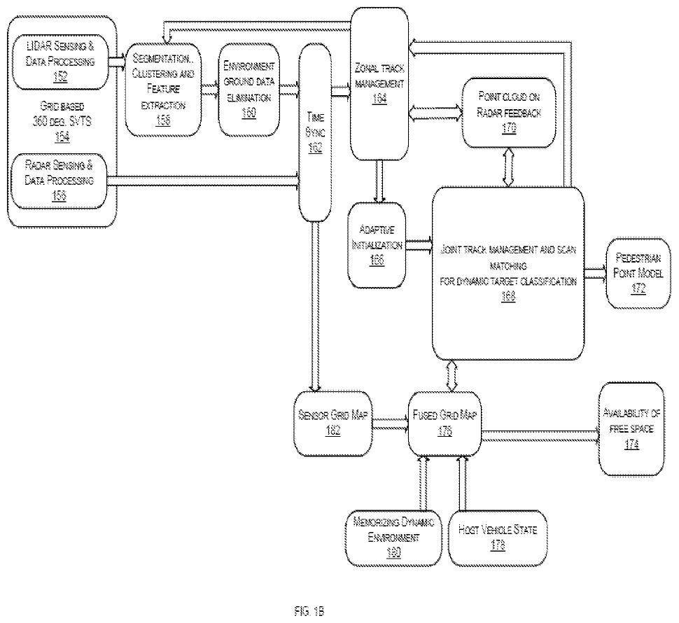

FIG. 1A illustrates overall working of lidar and radar based tracking system and FIG. 1B illustrates architecture of the system in accordance with an exemplary embodiment of the present disclosure.

In an aspect, lidar and radar based tracking system (interchangeably termed as system 100 herein) includes an input 102, a processing unit 104 and an output unit 114.

The input unit 102 has one or more lidar sensors (interchangeably termed as lidars herein) and one or more radar sensors (interchangeably termed as radars herein) to sense surrounding of a vehicle. Blocks 152 and 156 forms 360° SVTS (surround view tracking system) 154 such that each of the one or more lidar sensors and one or more radar sensors sense the one or more objects in a corresponding region. The sensors are configured on surface of the vehicle to sense the objects in corresponding one or more majorly non-overlapping regions to capture 360 degree view around the vehicle.

Processing unit 104 receives the data from the input unit 102. At block 158, segmentation clustering and feature extraction is performed, where the lidar data point cloud is converted to Cartesian co-ordinate system. Further, features of dimension, extreme and corner of the targets are identified using robust segment fitting and probabilistic dimension derivation. At block 160, environment ground data is eliminated from the lidar data based on height of data points w.r.t ground and surface normal computation.

Thereafter, at step 106, the processing unit 104 maps the received lidar data and the received radar data in corresponding one or more grid maps of the one or more lidar sensors and the one or more radar sensors using zone track management 164 using time synchronization 162. At step 108, the processing unit 104 tracks the one or more objects in one or more regions corresponding to the one or more lidar sensors and the one or more radar sensors and performs state estimation for the one or more objects that are not sensed by any of the one or more lidar sensors and the one or more radar sensors.

In an embodiment, track and state estimation in respective regions may be achieved by zone tracking confidence establishment, which is in integral part for centralized track management. Zone tracking confidence establishment is useful for track management in non-sensing region (region not covered by any perception sensors). It includes techniques such as non-sensing region identification, zone classification and region based tracking, estimation technique selection, tracking time and sensing confidence.

The zone track management 164 provides feedback to segmentation clustering and feature extraction block 158 which further reduces computation burden by scanning the area adjacent to existing tracked object for clustering and thereby improves clustering phenomenon. Other clusters for new objects are segmented based on nearest neighbour mapping and segmentation.

At block 162, lidar and radar data synchronization is performed. The sensed data from the lidar sensors (after segment clustering and feature extraction 158 and environment ground data elimination 160) and the radar sensors are time synchronized based on sequential approach. Further, track management and prediction updates may be performed based on information available from the sensors.

In context of the present example, adapted initialization for surround view tracking is performed at block 166 for integrated fusion of radar, lidar and vehicle sensors for a zone. The one or more objects are tracked in the one or more regions by performing track initialization which further uses lidar and radar track management for tracking of the one or more one or more objects to obtain local radars and local lidars tracks, which is further explained below with reference to track initialization module 212.

At step 110, the processing unit 104 fuses the one or more grid maps of the one or more lidar sensors and the one or more radar sensors by converting said one or more grid maps from sensor frame to vehicle frame to generate a fused grid map at block 176 (using inputs from blocks 182, 178 and 180).

At step 112, the processing unit 104 integrates the fused grid map with any or a combination of track management and scan matching for dynamic target classification 168 for classification of the one or more objects into static objects or dynamic objects and identification of free space in the fused grid map. The output of block 168 may be used for pedestrian classification in pedestrian point model 172.

In an aspect, when the one or more objects are tracked in the one or more regions, the processor 104 performs track initialization based on: target information, track history, sensor type involved in track initialization; weighted fusion based velocity estimation of the tracked one or more objects based on lidar and radar tracking time; and occlusion identification based on the one or more objects sensed by the one or more radar sensors in addition to occlusion identified by Lidar sensors.

According to an embodiment, the system 100 integrates sensed signals from radar and lidar pre-processed data. The technique uses initialization of track based on post-processing of sensed signals from radar and lidar sensors, and identification and classification of target feature from cluster signals from lidar and radar sensed signals. The system 100 includes multi target track management and sensor data fusion comprising synchronization, track initialization, centralized track management, fused grid map and target classification in grid. Furthermore, the system 100 determines availability of free space. In an embodiment, environment ground data is eliminated (at block 160) based on surface normal computation.

At block 174, based on grid fusion 176 integrated with track management, availability of free space is determined. The output unit 114 may be a display device or any other audio-visual device that provides indicates detected free space to the user.

According to an embodiment, the system 100 uses an out of sequence strategy for cascaded track management. The strategy involves update of the sensor fusion with signals from recipient multiple sensors with varied time intervals. The out of sequence strategy deals with problem of difference of signal recipient by varied sensors. It decides discretion for sensor fusion or dependence on individual sensor and thereby state and covariance update at specific instances. At block 162, the signals, which are outcome of different sensors are received at different intervals are synchronized for data fusion and validation. The discrepancy of the signal receiving timing is resolved by the following strategies: the signal from each sensor is tackled by time synchronization mechanism where the synchronization is based on data points from front lidar. Front lidar and rear lidar are synchronized during installation and data from other side sensors is be mapped with respect to front lidar time frame i.e. the data of other sensors is processed in multiple of sensing time frame of front lidar. As front lidar executes at 0.08 sec the processing delay of other side sensors will be significantly less.

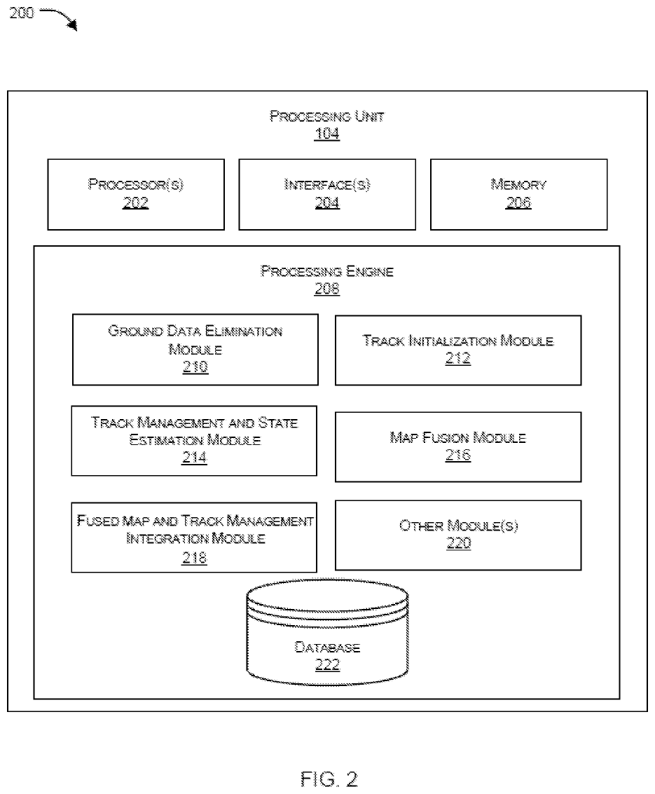

FIG. 2 illustrates exemplary modules of a processing unit in accordance with an embodiment of the present disclosure.

Present disclosure elaborates upon a system implemented in a host vehicle for tracking of one or more objects to identify free space. As elaborated in FIG. 1 above, the system comprises an input unit 102 that provides lidar data and radar data to a processing unit 104.

In an aspect, the processing unit 104 may comprise one or more processor(s) 202. The one or more processor(s) 202 may be implemented as one or more microprocessors, microcomputers, microcontrollers, digital signal processors, central processing units, logic circuitries, and/or any devices that manipulate data based on operational instructions. Among other capabilities, the one or more processor(s) 202 are configured to fetch and execute computer-readable instructions stored in a memory 206 of the processing unit 104. The memory 206 may store one or more computer-readable instructions or routines, which may be fetched and executed to create or share the data units over a network service. The memory 206 may comprise any non-transitory storage device including, for example, volatile memory such as RAM, or non-volatile memory such as EPROM, flash memory, and the like.

The processing unit 104 may also comprise an interface(s) 204. The interface(s) 204 may comprise a variety of interfaces, for example, interfaces for data input and output devices, referred to as I/O devices, storage devices, and the like. The interface(s) 204 may facilitate communication of processing unit 104 with various devices coupled to the processing unit 104 such as the input unit 102 and the output unit 106. The interface(s) 204 may also provide a communication pathway for one or more components of the processing unit 104. Examples of such components include, but are not limited to, processing engine(s) 208 and data 210.

The processing engine(s) 208 may be implemented as a combination of hardware and programming (for example, programmable instructions) to implement one or more functionalities of the processing engine(s) 208. In examples described herein, such combinations of hardware and programming may be implemented in several different ways. For example, the programming for the processing engine(s) 208 may be processor executable instructions stored on a non-transitory machine-readable storage medium and the hardware for the processing engine(s) 208 may comprise a processing resource (for example, one or more processors), to execute such instructions. In the present examples, the machine-readable storage medium may store instructions that, when executed by the processing resource, implement the processing engine(s) 208. In such examples, the processing unit 104 may comprise the machine-readable storage medium storing the instructions and the processing resource to execute the instructions, or the machine-readable storage medium may be separate but accessible to processing unit 104 and the processing resource. In other examples, the processing engine(s) 208 may be implemented by electronic circuitry.

The data 222 may comprise data that is either stored or generated as a result of functionalities implemented by any of the components of the processing engine(s) 208.

In an exemplary embodiment, the processing engine(s) 208 may comprise a ground data elimination module 210, track initialization module 212, a track management and state estimation module 214, a map fusion module 214, a fused map and track management integration module 218 (also referred to as integration module 218, hereinafter) and other modules 220.

It would be appreciated that modules being described are only exemplary modules and any other module or sub-module may be included as part of the system 100 or the processing unit 104. These modules too may be merged or divided into super-modules or sub-modules as may be configured.

### Ground Data Elimination Module 210

In an aspect, the ground data elimination module 210 receives lidar data from the one or more lidar sensors and radar data from the one or more radar sensors and maps the received lidar data and the received radar data in corresponding one or more grid maps of the one or more lidar sensors and the one or more radar sensors.

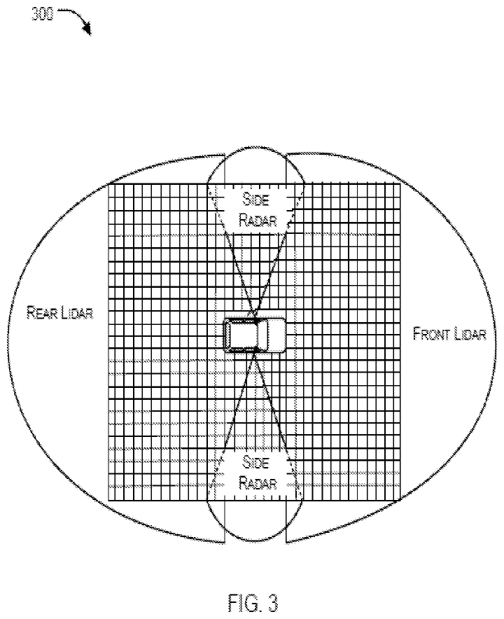

As illustrated in FIG. 1A, the input unit 102 provides lidar data and radar data to the processing unit 104 for use by ground data elimination module 210 as described above. Referring to FIG. 3, grid based 360 degree surround view system is established multiple lidar and radar sensors. In an example, lidar sensors with 180 degree beam angle are mounted in front of vehicle and at the rear of vehicle, whereas two radar sensors with 45 degrees beam angle are mounted in the sideways of vehicle.

Thus, the input unit 102 has one or more lidar sensors and one or more radar sensors to sense surrounding of the vehicle such that each of the one or more lidar sensors and one or more radar sensors sense the one or more objects in a corresponding region. The one or more lidar sensors and the one or more radar sensors are configured on surface of the vehicle to sense the objects in corresponding one or more majorly non-overlapping regions to capture 360 degree view around the vehicle.

In an embodiment, the ground data elimination module 210 eliminates one or more data points pertaining to ground, from each grid map, by computing a surface normal plane using at least three data points selected from the lidar data. The at least three data points are spaced at a distance less than a pre-defined threshold among each other. Further, elimination of the one or more data points pertaining to the ground is performed by computing height of each data point from the ground and considering target distance height of the lidar sensor with the computed surface normal plane. Thus, ground data may be eliminated based on an integrated approach of mathematical computation of height of the individual points from ground considering the target distance-height of lidar sensor with normal of plane created from data points and computing a surface normal plane using at least three data points selected from any or a combination of the lidar data.

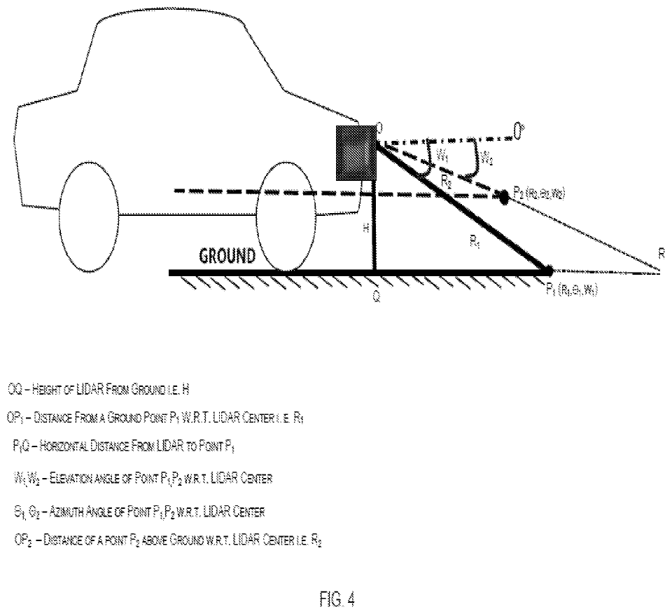

In an embodiment, the ground data elimination module 210 performs environment ground data elimination based on height of ground data points and surface normal computation as illustrated in FIG. 4.

In context of the present example, high-level sensor fusion is performed based on the movement of target objects. Firstly, background subtraction is performed based on not tracked object outside grid. Considering, a lidar sensor is mounted on vehicle front or rear at height (H), under right-angled triangle (OP₁Q):

OP₁=H/sin [symbol] (ω1) (1)

In case P₁Pl being a ground point, R₁rl should be approximately equal to OP₁OPl (approximately).

Similarly, for a non-ground point (for instance P2), a right-angled triangle (OQR),

OR=H/sin [symbol] (ω2) (2)

In such a case, R₂ for a point P₂P2 is smaller than OR. That is R₂<OR

In context of the present example, from the filtered data points from above approach, missed-out ground data point is re-evaluated and eliminated, using normal calculation and selecting three consecutive data points in space, such that the distance between them does not exceed a pre-defined distance threshold.

$$\text{?} \\ \text{?} \text{indicates text missing or illegible when filed} \qquad ( 3 )$$

Importantly, as all points are on the ground, thereby, the normal is directed towards upwards (i.e. z-axis). Further, the coplanarity of all the points are also considered based on normal computation from multiplication of vectors created from joining selected points. Thus, the ground points are segregated from other non-ground points based on normal of the plane directing upwards. By the process, the ground points may be eliminated. Further, certain threshold may be added, in case the normal is not completely aligned to z-axis, although being a ground point (for some non-planar ground point). From either of the two vectors, approximate directions towards which the normal is directed may be determined.

### Track Initialization Module 212

In an aspect, when the one or more objects are tracked in the one or more regions, in accordance with block 166, the track initialization module 212 performs adaptive initialization for surround view tracking system (SVTS). The integrated fusion in a region is performed by integration of data from radar, lidar and vehicle sensors. The lidar sensors predominantly play major role for object classification and initialization of tracks.

In context of the present example, track initialization and management is performed to ensure that the track is maintained while at least one object of the one or more object transitions from regions of a first sensor to region of a second sensor, the first sensor and the second sensor are selected from the one or more lidar sensors and the one or more radar sensors. The track initialization is based on zone and sensor type involved, where track of a dynamic object is initialized based on lidar based track management and track is managed and maintained further as the dynamic object moves from lidar zone to radar zone. The track initialization depends on the confidence of sensing inputs, track time, zone, motion dynamics and traffic direction. However, probable tracks may be created if target appears in radar zone and moves to lidar zone, and thereby the essentially reducing the initialization period. Following may be considered for track initialization:

TrackInitialization_Time=w₁*LIDARTrackTime+w₂*RadarTrackTime (11)

Where, w1, w2: Tuneable weightage factor

Further, weighted fusion based velocity estimation of the tracked one or more objects is performed based on lidar and radar tracking time. Herein, velocity vectors of the classified objects are based on weighted factors as radar provide highly accurate velocity with respect to derived velocity vectors from LIDAR point cloud. Following relations may be considered for computation of velocity:

Vₓ=w_{LIDAR}*vₓ_{_{LIDAR}}*TrackMaintenanceTime_{LIDAR}+w_{Radar}*Vₓ_{_{RADAR}}*TrackMaintenanceTime_{RADAR} (13)

V_{y}=w_{LIDAR}*V_{y}_{_{LIDAR}}*TrackMaintenanceTime_{LIDAR}+w_{Radar}*V_{y}_{_{RADAR}}*TrackMaintenanceTime_{RADAR} (14)

where, Vx, Vy: Estimated Velocity and W_{LIDAR}, W_{RADAR}: Weightage factors
TrackMaintenanceTime_{RADAR}: Time for maintaining track while target is tracked by Radar or track lie under radar zone
TrackMaintenanceTime_{LIDAR}: Time for maintaining track while target is tracked by Lidar or track lies under Lidar zone

Those skilled in the art would appreciate that track management ensures that track is maintained while the target track makes transition from region of one sensor to adjacent sensor. The target track may be predicted over a period to ensure smooth transition from one region to another region.

### Track Management and State Estimation Module 214

In an aspect, track management and state estimation module 214 tracks the one or more objects in one or more regions corresponding to the one or more lidar sensors and the one or more radar sensors and performs state estimation for one or more objects that are not sensed by any of the one or more lidar sensors and the one or more radar sensors.

Those skilled in the art would appreciate that track and state estimation in respective regions is an intricate part for constructing centralized track management. In the non-sensing area, the state estimation is updated based on track history till the object enters into the region of adjacent sensor. The state estimation is validated across the measurements and data association to ensure the track management while transition from one sensor region to adjacent sensor region.

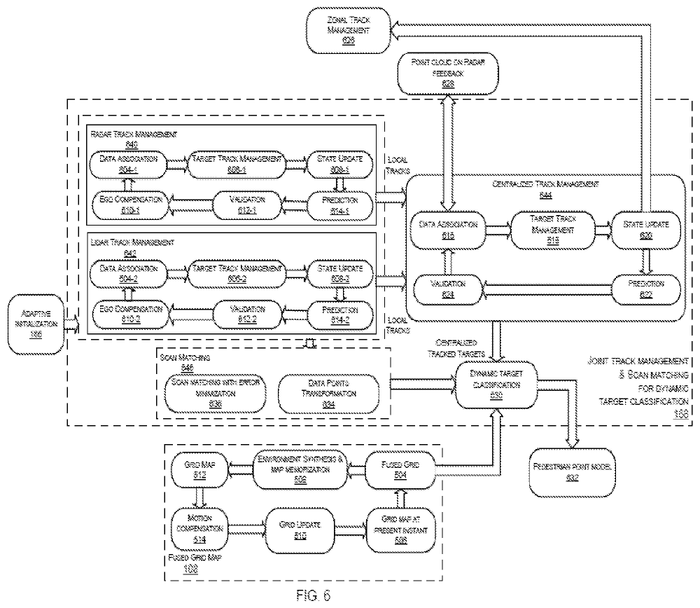

In an embodiment, joint (integrated) track management and scan matching is performed for dynamic object classification. The above mentioned techniques include prediction and data association on fused grid map where all radar and lidar data gets fused to form a grid occupancy map. The clustered and segmented data of the track management is evaluated against the scan matching of the grid map data. The objective function optimization methodology is used to find the dynamic objects from integrated track management and scan matching algorithm. In an embodiment, track management is performed in accordance with block diagram of FIG. 6

In context of the present example, radar track management 640 and lidar track management 642 may create local tracks based on data association 604-1 and 604-2, target track management 606-1 and 606-2, state update 608-1 and 608-2, prediction 614-1 and 614-2, validation 612-1 and 612-2 and ego compensation 610-1 and 610-2. The local tracks may be fed to centralized track management 644, which associates both lidar and radar local tracks, and provides centralized target tracks. The scan matching 646 takes the input from local tracks of lidar and radar along with centralized track to map the data w.r.t to previous instance and thereby determines the dynamic objects. At block 636, scan matching with error minimization is performed and at block 634, data point transformation is performed. Scan matching 636 is performed by finding out nearest neighbour in point cloud and using Iterative Closest Point (ICP) of point cloud data. Error minimization is performed by minimizing error metrics and transformation 634 is performed by transforming the point cloud using results of minimization. In an example, as iterative process is performed, the point cloud scanned for present instant may be compared with previous information, thereby identifying the dynamic objects. The dynamic object classification 630 further segregates the objects into static or dynamic based on input from scan matching 636 and derived velocity of object from centralized track management 644. Further, the pedestrian point model 632 identifies pedestrian which essentially segregate pedestrians from target vehicles.

Those skilled in the art would appreciate that target track management 618 includes the track history maintenance, track deletion and addition and state update 620 including state estimation may be performed considering target positions, velocity vector. Prediction 622 may be performed using Kalman filter. Further, validation 624 includes validation and gating of the prediction w.r.t to present measurements. Data association 616 includes associating track w.r.t measurement and may be performed using conventional probabilistic data association filter. Also, ego compensation of vehicle may be performed by transforming the data to present vehicle frame based vehicle states (e.g. yaw rate, roll rate and vehicle velocity).

In an embodiment, the target track is initialized in adaptive initialization 166 and fed to radar track management 640 and lidar track management 642 for initialization of tracks, which may further be taken for centralised track management 644. The associated tracks from data association 616 may be taken for formulating track history and to determine the characteristic of point cluster (e.g. maximum and minimum deviation of data points, standard deviation of data points w.r.t reference line connecting extreme and corner points of target). The track history and characteristic of data point cloud provide aids to the radar feedback to re-construct the similar point cloud over the same specified radar local track of specified target, which helps to create mapping of the surrounding environment.

Those skilled in the art would appreciate that zonal track management 626 is an intricate part that aids centralized track management 644. In the non-sensing area, the state estimation may be updated till it gets into the region of adjacent sensor. The state estimation is validated across the measurements and data association ensures the track management while transition from one senor region to adjacent sensor. Further, zonal track management 626 helps in track maintenance, while at least one object of the one or more object transitions from regions of a first sensor to region of a second sensor, wherein the first sensor and the second sensor are selected from the one or more lidar sensors and the one or more radar sensors

In an embodiment, a zone tracking confidence establishment may be a part of zonal track management 626, which is useful for track management in non-sensing region (region not covered by any perception sensors) by performing operations such as non-sensing region identification, zone classification and region based tracking, estimation technique selection, tracking time determination and sensing confidence computation.

The zone tracking confidence establishment may also provide feedback to segmentation and clustering algorithm which further reduces computation burden by scanning the area adjacent to existing tracked object for clustering and thereby improves clustering phenomenon. Other clusters for new objects are segmented based on nearest neighbour mapping and segmentation.

Furthermore, in an embodiment, occlusion identification is performed based on the one or more objects sensed by the one or more Lidar or radar sensors. Occlusion detection plays critical role in identification of occlusion and thereby enabling target track estimation during occlusion. In case the target is in critical zone of Lidar, any target having track history in other zone in same side will be predicted over period unless the vehicle in close vicinity moves out. The algorithm additionally provides to deal with occlusion due to object detected by radar only. Occlusion time identified by Radar may be the function of zone, target track history and sensor confidence.

### Map Fusion Module 216

In an aspect, the map fusion module 216 fuses the one or more grid maps of the one or more lidar sensors and the one or more radar sensors by converting the one or more grid maps from sensor frame to vehicle frame to generate a fused grid map.

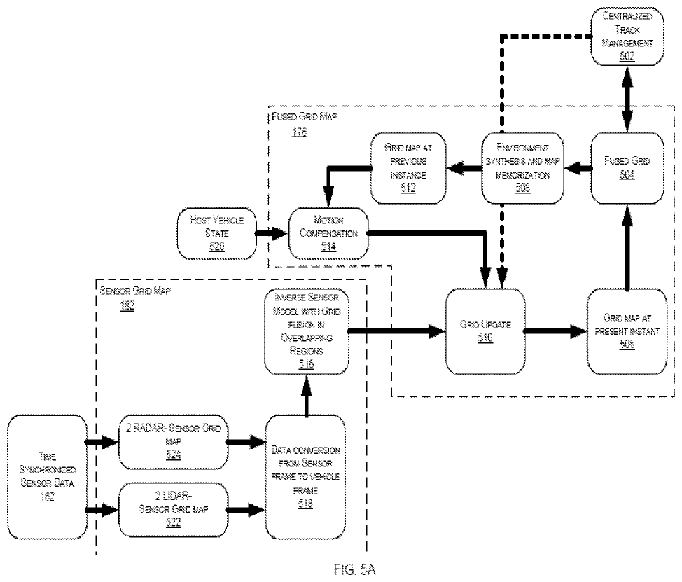

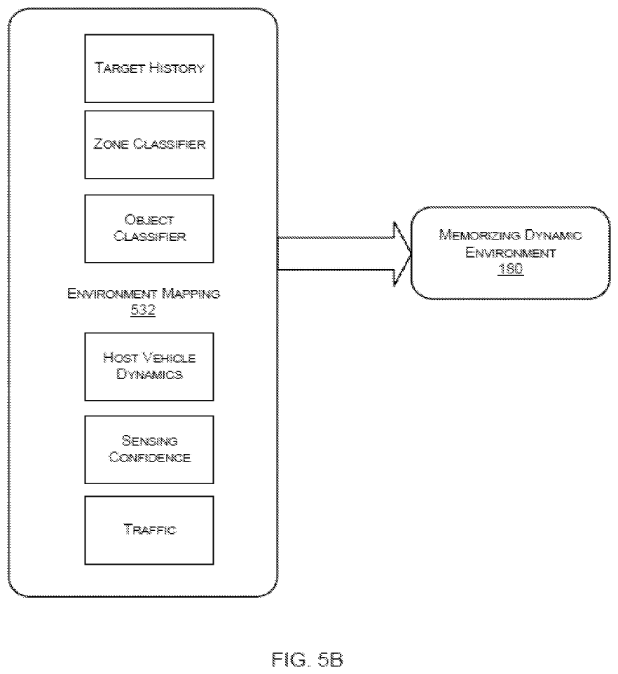

As shown in FIG. 5A, fused grid 504 is assimilation of grid maps developed by individual sensors i.e. two grid maps of radar sensors 524 and two grid maps of lidar sensors 522. The sensor grid maps (524 and 522, generated using time synchronizes data 162) may be developed in logarithmic scale. The input data may be converted from sensor frame to local vehicle frame at block 518. The fusion of overlapping regions of radar and lidar is performed on grid map at block 516. Further, using fused grid 504, the map fusion module 216 synthesizes an environment to create an environment map at block 508, and the environment map is memorized to be used for performing the classification of the one or more objects for identification of free space in the fused grid map. The memorized environment map may be used for grid update at block 510. Further, at block 502, the fused grid 504 may be integrated with track management to perform the dynamic object management.

In an embodiment, the grid update 510 is used to determine the grid map at present instant 506. The grid update 510 is performed based on inverse sensor model 516 and motion compensation 514. The motion compensation 514 performs ego motion compensation of the of grid map at previous instance 512 based on motion of the host vehicle 520 i.e. vehicle states e.g. vehicle speed and yaw rate. Environment synthesis/mapping and map memorization 508 provides input to grid map at previous instance 512. Further, grid adaptation is performed where, grid occupancy based on ego vehicle sensor data is adapted and ego compensation is provided on the grid. The grid map may be rotated or transformed in present vehicle frame depending on the vehicle states e.g. velocity and yaw rate of host vehicle.

.=is the estimated resultant position from probabilities of measurement model and motion model In an embodiment, a fused grid is formed based upon inputs from an inverse sensor model that uses initialized grid and track information obtained from track management and scan matching. As the grid starts to decay, grid decay and track history is used for grid update. The composite information from track management and scan matching helps to identify and track the dynamic objects on grid and thereby identify the free availability of space for the vehicle to navigate.

In an embodiment, map fusion module 216 performs environment synthesis and map memorization. As illustrated in FIG. 5B, environment synthesis is used to create map, the map is memorized for dynamic object identification and free space detection. The module 214 performs fused grid based environment mapping for surround view tracking system (the invention) incorporating aspects of:

a) Confidence level of sensed perception data;

b) Zone definition: Highly critical, critical, semi-critical, non-critical;

c) Object classifier: Pedestrian, Vehicle;

d) Host vehicle dynamics: Lateral or longitudinal motion; and

e) Traffic congestion: Congested, sparsely congested, Non-congested.

Fused Map and Track Management Integration module 218

In an aspect, the integration module 218 along with the map fusion module 216 integrates the fused grid map with any or a combination of track management and scan matching to perform classification of the one or more objects into static objects or dynamic objects and identification of free space in the fused grid map.

In an embodiment, when at least one object of the one or more objects is a pedestrian, fused map and track management integration module 218 classifies the at least one object using: size of a point cloud pertaining to the pedestrian, obtained from the lidar data, with respect to longitudinal, lateral distance from the vehicle and zone of the point cloud: structure and availability of the point cloud in one or more channels of the one or more lidar sensors; a deterministic velocity vector of the point cloud indicating velocity vector of the pedestrian: and history of trajectory of the point cloud. In an embodiment, the integration module 218 uses a stochastic approach for pedestrian classification which is part of dynamic or moving object classifications.

In context of the present example, a stochastic approach for pedestrian classification may be part of dynamic or moving object classifications. The target pedestrian may be classified after clustering using following specific information:
1) point cloud size with respect to longitudinal distance and zone;
2) availability of pedestrian data points in various channel which is indirectly based on the height of pedestrian;
3) the structure of point cloud available in channels of the lidar sensors (e.g. four channels);
4) the deterministic velocity vector of point cloud which resemble the velocity vector of a pedestrian (track history);
5) the trajectory history of the pedestrian point cloud;

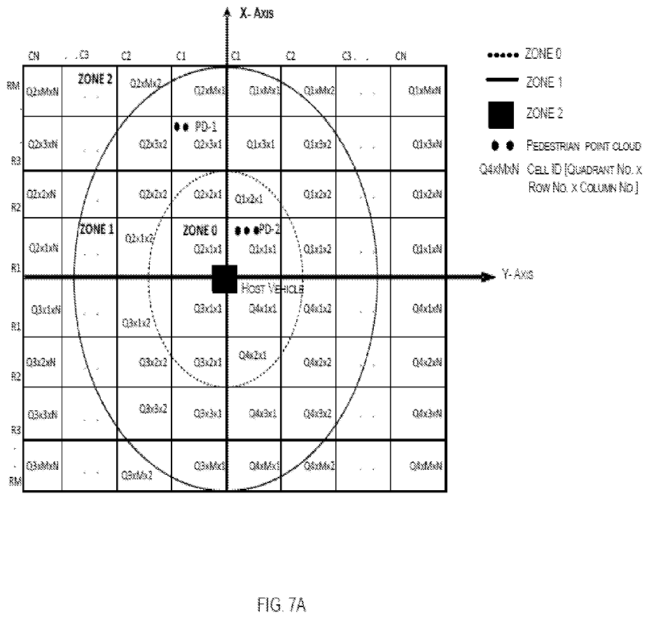

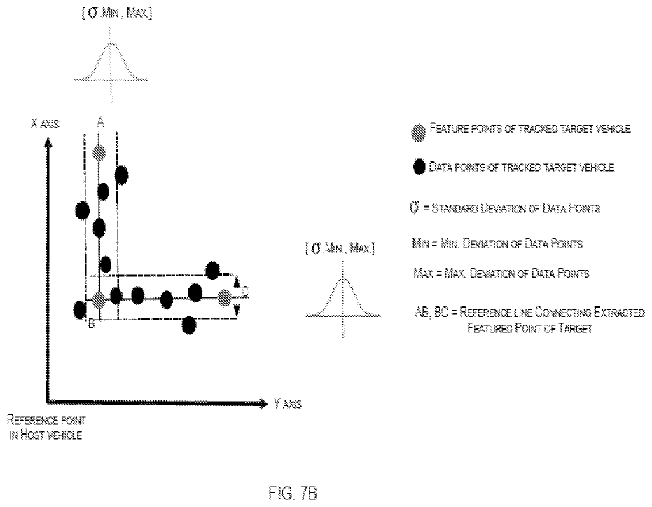

In an embodiment, FIG. 7A illustrates point cloud distribution for a pedestrian, where pedestrian point model or dimension of point cloud is function of longitudinal relative position, lateral relative position and recipient channel at which the LIDAR receives the information from LIDAR.

Constraints of behavioural model of pedestrian may be:

Lower Pedestrain Dimension<PedestrianPointModel<Upper Pedestrain Dimension (10)

Where, pedestrian dimension refers to width and height of pedestrian.

The further selection of segmented point cloud associated with pedestrian may be based on velocity vector.

In an embodiment, the fused map and track management integration module 218 reconstructs and maps one or more cluster points, resembling lidar point cloud data, on one or more data points obtained from radar data for mapping of the one or more objects on the fused grid to form complete surroundings around the host vehicle.

In an embodiment, local tracks of radar sensors and lidar sensors are used for reconstruction and mapping of lidar cluster points on radar data (i.e. where lidar data point cloud is not present, reconstruction of point cloud on radar data point for target mapping is performed, thereby determining actual free space detection).

As shown in FIG. 7B, the lidar cluster is re-mapped to radar feedback and tracked object so that the efficiency of whole grid is established. The objects on the grid with point cloud may be re-structured on tracked object to specify the characteristic, feature, dimension of the classified objects. The distribution of point cloud over radar feedback is based on the history of data point distribution in association with referred target.

The history of point distribution may have following characteristics:

a) Standard deviation of the point cloud w.r.t to the reference line constructed while connecting extreme feature points with the corner feature point (e.g. reference lines AB or BC as shown in FIG. 7B).
b) Minimum and maximum deviation of data points from reference line connecting extracted feature point of target.

$$\text{?} \qquad ( 11 )$$

$$\text{?} \qquad ( 12 )$$

$$\text{?} \qquad ( 15 )$$

$$\text{?} \\ \text{?} \text{indicates text missing or illegible when filed} \qquad ( 16 )$$

Time for maintaining track Time for maintaining track

### Other Modules 220

In an aspect, other modules 220 implement functionalities that supplement applications or functions performed by the system 100, processing unit 104 or the processing engine(s) 208.

Although the proposed system has been elaborated as above to include all the main modules, it is completely possible that actual implementations may include only a part of the proposed modules or a combination of those or a division of those into sub-modules in various combinations across multiple devices that may be operatively coupled with each other, including in the cloud. Further the modules may be configured in any sequence to achieve objectives elaborated. Also, it may be appreciated that proposed system may be configured in a computing device or across a plurality of computing devices operatively connected with each other, wherein the computing devices may be any of a computer, a smart device; an Internet enabled mobile device and the like. Therefore, all possible modifications, implementations and embodiments of where and how the proposed system is configured are well within the scope of the present invention.

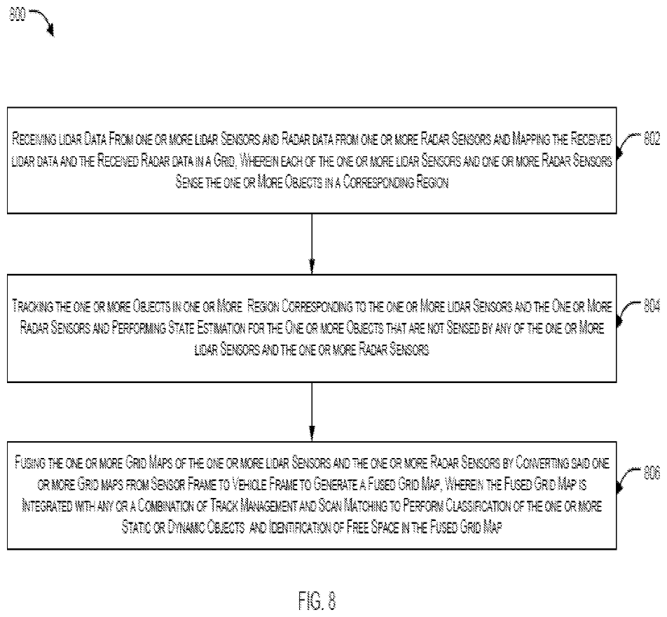

FIG. 8 illustrates a method of performing lidar and radar based tracking in accordance with an exemplary embodiment of the present disclosure.

In an aspect, the proposed method may be described in general context of computer executable instructions. Generally, computer executable instructions can include routines, programs, objects, components, data structures, procedures, modules, functions, etc., that perform particular functions or implement particular abstract data types. The method can also be practiced in a distributed computing environment where functions are performed by remote processing devices that are linked through a communications network. In a distributed computing environment, computer executable instructions may be located in both local and remote computer storage media, including memory storage devices.

The order in which the method as described is not intended to be construed as a limitation, and any number of the described method blocks may be combined in any order to implement the method or alternate methods. Additionally, individual blocks may be deleted from the method without departing from the spirit and scope of the subject matter described herein. Furthermore, the method may be implemented in any suitable hardware, software, firmware, or combination thereof. However, for ease of explanation, in the embodiments described below, the method may be considered to be implemented in the above described system.

In an aspect, present disclosure elaborates upon a method, carried out according to instructions stored in a computer implemented in a vehicle for tracking of one or more objects to identify free space. The method comprises, at step 802, receiving lidar data from one or more lidar sensors and radar data from one or more radar sensors and mapping the received lidar data and the received radar data in a grid, wherein each of the one or more lidar sensors and one or more radar sensors sense the one or more objects in a corresponding region; and at step 804 tracking the one or more objects in one or more region corresponding to the one or more lidar sensors and the one or more radar sensors and performing state estimation for the one or more objects that are not sensed by any of the one or more lidar sensors and the one or more radar sensors.

The method further comprises, at step 806, fusing the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more static or dynamic objects and identification of free space in the fused grid map.

Those skilled in the art would appreciate that some of the important techniques utilized by various aspects of the present disclosure include track initialization, lidar and radar based surround view system, joint track management, fused grid based environment mapping, stochastic approach for pedestrian classification for out of sequence measurement from camera and radar sensors.

The grid based fusion methodology described above enhances the possibility of scanning complex environment of crowded cities and un-predictable movement of vehicles and pedestrians therein. It also helps to manage tracking of non-linear and highly manoeuvring mobile targets, and provides detailed information for free space availability that may be used for parking or host vehicle navigation. Furthermore, lidar and radar based fused surround view tracking system described herein is extremely accurate in terms of position and velocity of targets (objects being tracked) as compared to existing camera based surround view tracking systems. The range of fused lidar and radar based tracking system is higher and hence an advantage over that of a camera based surround view tracking system.

Surround view tracking enabled by invention disclosed may be well used for autonomous operation of vehicles it is implemented in for aspects such as valet parking, traffic jam pilot or highway pilot operation.

As would be readily appreciated, while primary application for disclosure as elaborated herein is in the automotive domain for pedestrian detection and free space detection, it may be used in non-automotive domain as well wherein any moving object may be similarly detected.

As used herein, and unless the context dictates otherwise, the term “coupled to” is intended to include both direct coupling (in which two elements that are coupled to each other or in contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### Advantages of the Invention

Present disclosure provides a system that integrates track management with grid mapping and uses multiple lidars and radars to enable a 360 degree target tracking and mapping.

Present disclosure provides a system that uses less computation power and is more responsive. Existing systems using 3D lidars are costly with a huge computation burden and create a blind zone of 5-10 meters approximately near the host vehicle as they are mounted on roof top of the vehicle. Further, proposed system provides a feedback mechanism for lidar clustering/segmentation and so reduces computation burden required for the lidar clustering/segmentation.

Present disclosure provides a system that has greater accuracy than camera based systems as it relies upon lidar sensors and radar sensors.

Present disclosure provides a system that eliminates ground data and consequent errors due to rough/turbulent ground surfaces. Proposed system eliminates ground data based on an integrated approach of mathematical computation of height of the points from ground considering the target distance−height of lidar with normal of plane created from data points. This is applicable for both plane and rough/turbulent ground surfaces.

Present disclosure provides a system that uses zone/region based tracking to improve tracking performance and helps in surround view creation/tracking of non-sensing region of any of the sensors (blind zone area tracking),

Present disclosure provides a system that identifies various occlusions with improved accuracy by both lidar and radar surround view tracking system. Existing system or prior art identifies occlusion using lidar sensor typically however present disclosure additionally identifies occlusions in radar zone using radar sensor and track management mechanism.

Present disclosure provides a system that improves zone/track initialization over conventional averaging techniques. The system uses weighted velocity estimation with radar and lidar tracking time which is an improved version over initialization using conventional averaging techniques.

Present disclosure provides for a system that has improved segregation of static and dynamic targets. The system uses a point method with stochastic approach for pedestrian classification which is the most challenging aspect of target classification and tracking. A system that is based on an improved approach of pedestrian detection.

Present disclosure provides a system that enables an optimum method of improved track management in turbulent surface (e.g. gravel area in parking).

Present disclosure provides a system that enhances the possibility of scanning complex environment of crowded city and un-predictable movement of vehicles and pedestrians.

Present disclosure provides a system that tracks the non-linear and highly manoeuvring movement of targets and provides information for free space availability for parking or host vehicle navigation.

Present disclosure provides a system that has increased range of consistent detection than camera based systems.

We claim:

1. A system implemented in a vehicle for tracking of one or more objects to identify free space, said system comprising:
an input unit comprising:
one or more lidar sensors and one or more radar sensors to sense surrounding of the vehicle, wherein each of the one or more lidar sensors and one or more radar sensors sense the one or more objects in a corresponding region;
a processing unit comprising a processor coupled with a memory, the memory storing instructions executable by the processor to:
receive lidar data from the one or more lidar sensors and radar data from the one or more radar sensors and map the received lidar data and the received radar data in corresponding one or more grid maps of the one or more lidar sensors and the one or more radar sensors;
track the one or more objects in one or more regions corresponding to the one or more lidar sensors and the one or more radar sensors and performing state estimation for the one or more objects that are not sensed by any of the one or more lidar sensors and the one or more radar sensors; and
fuse the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more objects into static objects or dynamic objects and identification of free space in the fused grid map.

2. The system of claim 1, wherein the one or more lidar sensors and the one or more radar sensors are configured on surface of the vehicle to sense the objects in corresponding one or more majorly non-overlapping regions to capture 360 degree view around the vehicle.

3. The system of claim 1, wherein the processor eliminates one or more data points pertaining to ground, from each grid map, by computing a surface normal using at least three data points selected from the lidar data and wherein the at least three data points are spaced at a distance less than a pre-defined threshold among each other.

4. The system of claim 3, wherein the processor eliminates the one or more data points pertaining to the ground by computing height of each data point from the ground and considering target distance height of the lidar sensor with the computed surface normal.

5. The system of claim 1, wherein when the one or more objects are tracked in the one or more regions, the processor performs track initialization and management based on:
a. track initialization and management to ensure that the track is maintained while at least one object of the one or more object transitions from regions of a first sensor to region of a second sensor, wherein the first sensor and the second sensor are selected from the one or more lidar sensors and the one or more radar sensors;
b. weighted fusion based velocity estimation of the tracked one or more objects based on lidar and radar tracking time; and
c. occlusion identification based on the one or more objects sensed by the one or more radar sensors.

6. The system of claim 1, wherein the processor further synthesizes an environment to create an environment map, and wherein the environment map is memorized to be used for performing the classification of the one or more objects for identification of free space in the fused grid map.

7. The system of claim 1, wherein when at least one object of the one or more objects is a pedestrian, the at least one object is classified using:
a. size of a point cloud pertaining to the pedestrian, obtained from the lidar data, with respect to longitudinal, lateral distance from the vehicle and zone of the point cloud;
b. structure and availability of the point cloud in one or more channels of the one or more lidar sensors;
c. a deterministic velocity vector of the point cloud indicating velocity vector of the pedestrian; and
d. history of trajectory of the point cloud.

8. The system of claim 1, wherein the processor reconstructs and maps one or more cluster points, obtained from lidar data, on one or more data points obtained from radar data for mapping of the one or more objects on the fused grid to form complete surroundings around the host vehicle.

9. A method, carried out according to instructions stored in a computer implemented in a vehicle for tracking of one or more objects to identify free space, comprising:
receiving lidar data from one or more lidar sensors and radar data from one or more radar sensors and mapping the received lidar data and the received radar data in a grid, wherein each of the one or more lidar sensors and one or more radar sensors sense the one or more objects in a corresponding region;
tracking the one or more objects in one or more region corresponding to the one or more lidar sensors and the one or more radar sensors and performing state estimation for the one or more objects that are not sensed by any of the one or more lidar sensors and the one or more radar sensors; and
fusing the one or more grid maps of the one or more lidar sensors and the one or more radar sensors by converting said one or more grid maps from sensor frame to vehicle frame to generate a fused grid map, wherein the fused grid map is integrated with any or a combination of track management and scan matching to perform classification of the one or more static or dynamic objects and identification of free space in the fused grid map.
